(19) United States
(12) Patent Application Publication
(10) Pub. No.: US 2026/0084842 A1
(43) Pub. Date: Mar. 26, 2026

(54) Spacecraft stability margin estimation using telemetry from spacecraft operations

(71) Applicant: The Charles Stark Draper Laboratory, Inc., Cambridge, MA (US)

(72) Inventor: Jimmy Jang, Cambridge, MA (US)

(21) Appl. No.: 19/312,431

(22) Filed: Aug. 28, 2025

Related U.S. Application Data
(60) Provisional application No. 63/697,586, filed on Sep. 22, 2024.

(51) Int. Cl. B64G 1/36; B64G 1/24; B64G 1/66

(52) U.S. Cl. CPC B64G 1/36; B64G 1/245; B64G 1/66

(57) ABSTRACT

A system for estimating stability margins of a vehicle includes one or more sensors configured to collect telemetry data during execution of an operational maneuver by a vehicle, wherein the operational maneuver is performed as part of a planned operational sequence of one or more maneuvers, one or more processors, and memory storing instructions that, when executed by the one or more processors, cause the system to process the telemetry data to determine a transfer function of a control system of the vehicle, the processing including applying one or more transformations to the telemetry data based on an order of a reference input command associated with the operational maneuver, and estimate one or more stability margins of the vehicle control system based on the transfer function.

### CROSS-REFERENCES TO RELATED APPLICATIONS

This application claims the benefit of U.S. Provisional Application No. 63/697,586 filed Sep. 22, 2024, the entire contents of which are incorporated herein by reference.

### BACKGROUND OF THE INVENTION

This invention relates to stability margin estimation using telemetry data for vehicle control systems.

Evaluating the stability of a vehicle's control system is critical to ensuring robust operation and preventing catastrophic failures. Conventional techniques for evaluating stability, including Monte Carlo simulations and frequency-domain stability margin analyses, are typically performed prior to vehicle deployment. These analyses rely on mathematical models of the vehicle dynamics and the Guidance, Navigation, and Control (GN&C) system, which are generally developed using approximations and linearizations. Frequency-domain methods also assume that the plant dynamics are time-invariant or change slowly over time.

While these simplifications are intended to bound expected operational scenarios, they suffer from fundamental limitations. Schedule and resource constraints limit the fidelity of pre-deployment analysis, resulting in incomplete coverage of the actual stability envelope. More critically, during actual vehicle operation, numerous parameters remain unknown or change over time. For spacecraft, these include vehicle mass properties (which change as fuel is consumed), structural flexibility characteristics, thruster performance degradation, and actuator health status. For undersea vehicles, parameters such as buoyancy changes, current-induced forces, and pressure-related structural deformations are similarly difficult to predict in advance. These unknown and time-varying parameters mean that pre-deployment stability analysis cannot accurately capture the vehicle's actual stability envelope during operation.

Vehicle instabilities can arise from various environmental and operational factors. For spacecraft, these include atmospheric drag variations, solar radiation pressure, magnetic field interactions, and micrometeorite impacts. For undersea vehicles, factors such as ocean currents, pressure variations with depth, and temperature gradients can induce instabilities. These environmental disturbances, combined with vehicle wear and degradation over time, make real-time stability assessment critical for maintaining safe and effective vehicle operation.

### SUMMARY OF THE INVENTION

To address the challenge of evaluating flight control system robustness during spacecraft operation, NASA's X-38 program proposed estimating real-time stability margins by injecting a narrow frequency band control signal into the flight control system during flight. The difference between the injected test signal and the resulting measured outputs is analyzed to predict vehicle stability. This approach enables in-flight assessment of the control system's stability margins. However, it suffers from practical limitations. Specifically, the magnitude of the injected signal must remain small to avoid altering the system's designed control performance or causing deviations from the planned reference trajectory. As a result, the predicted stability results are only valid within a very limited portion of the flight envelope, restricting the general applicability of this method.

Aspects described herein relate to a different approach for real-time stability margin estimation. Rather than injecting test control signals into the control system, aspects described herein estimate real-time stability margins using telemetry data from planned on-orbit operations like attitude and rate maneuvers (sometimes referred to as “operational maneuvers”). The estimated real-time, in-flight stability margins can be used as an early warning signal for instability

As used herein, an “operational maneuver” refers to a maneuver that is executed by a vehicle to achieve a functional objective related to the vehicle's intended mission or purpose, as distinguished from synthetic test maneuvers designed solely to probe system dynamics. Operational maneuvers result in meaningful changes to the vehicle's state (such as orientation, position, or velocity) that serve mission objectives, such as pointing a spacecraft's instruments at a target, maintaining orbital position, or navigating to a destination. In contrast, synthetic test maneuvers, such as those described in prior approaches like the X-38 program, involve injecting small-amplitude perturbation signals that are specifically designed to minimally affect the vehicle's operational state while exciting system dynamics for identification purposes. Operational maneuvers are characterized by reference commands that fully transition the vehicle from one operational state to another, rather than superimposing small perturbations on an existing trajectory. For example, a spacecraft performing a 5-degree attitude adjustment to point its antenna at Earth is executing an operational maneuver, whereas injecting a 0.1-degree sinusoidal wobble to measure frequency response would be a synthetic test maneuver. The systems and methods described herein advantageously extract stability information from operational maneuvers that the vehicle would perform regardless of any stability assessment needs, eliminating the operational disruption and limited validity envelope associated with synthetic test signal injection.

In some aspects, the technological innovation described herein transforms operational vehicle telemetry into actionable stability metrics by addressing fundamental numerical instabilities that have prevented real-time implementation. Specifically, the invention addresses the technical problem that arises when attempting to compute transfer functions from step-input maneuvers—the Fast Fourier Transform of step inputs produces zero values at all frequencies except DC, making conventional frequency-domain division numerically unstable or undefined. By exploiting the polynomial nature of operational maneuvers and applying tailored difference operations, the system avoids these numerical instabilities while operating within the computational and memory constraints of embedded vehicle systems. This technological improvement enables real-time safety monitoring that was previously impossible, providing early warning of control system degradation before catastrophic failure occurs.

In a general aspect, a system for estimating stability margins of a vehicle includes one or more sensors configured to collect telemetry data during execution of an operational maneuver by a vehicle, wherein the operational maneuver is performed as part of a planned operational sequence of one or more maneuvers, one or more processors, and memory storing instructions that, when executed by the one or more processors, cause the system to process the telemetry data to determine a transfer function of a control system of the vehicle, the processing including applying one or more transformations to the telemetry data based on an order of a reference input command associated with the operational maneuver, and estimate one or more stability margins of the vehicle control system based on the transfer function.

Aspects may include one or more of the following features.

The telemetry data may comprise one or more of attitude measurements, angular rate measurements, position measurements, velocity measurements, acceleration measurements, and force measurements. Processing the telemetry data by applying the one or more transformations may include computing differenced telemetry data by applying a difference operation to the telemetry data according to the order of the reference input command. The system may determine the order of the reference input command associated with the operational maneuver. Processing the telemetry data may further comprise applying a Fast Fourier Transform to the differenced telemetry data.

The reference input command may include a polynomial reference input of the form r(t)=t^{m}, where m is a nonnegative integer. m=0 may correspond to a step input, m=1 may correspond to a ramp input, and m=2 may correspond to a parabolic input. The system may process the telemetry data by applying a k^{th} order difference operation to the telemetry data, where k=m+1. The system may process the telemetry data to determine the transfer function without using input command signals in the transfer function computation.

The planned sequence of operational maneuvers may comprise a mission plan for the vehicle. The transfer function may be a closed-loop transfer function representing a frequency response from reference commands to measured outputs. The system may estimate the one or more stability margins by applying Multiple Input Multiple Output (MIMO) stability margin theory to the closed-loop transfer function. The system may apply MIMO stability margin theory by determining a maximum singular value of the closed-loop transfer function at each frequency and computing gain margins based on a minimum uncertainty radius determined from the maximum singular value of the closed-loop transfer function at each frequency.

The operational maneuver may comprise at least one of an attitude maneuver or a rate maneuver. The system may store the estimated stability margins in a data store with corresponding timestamps for post-operation analysis. The system may automatically adjust control parameters of the vehicle control system based on the estimated stability margins to maintain desired stability margins as vehicle dynamics change. The system may generate an alert when at least one of the estimated stability margins falls below a predetermined threshold value.

In another general aspect, a method for estimating stability margins of a vehicle control system includes receiving telemetry data collected during execution of an operational maneuver by a vehicle, wherein the operational maneuver is performed as part of a planned sequence of one or more operational maneuvers, processing the telemetry data to determine a transfer function of the vehicle control system, the processing including applying one or more transformations to the telemetry data based on an order of a reference input command associated with the operational maneuver, and estimating one or more stability margins of the vehicle control system based on the transfer function.

In another general aspect, software embodied on a non-transitory computer-readable medium includes instructions that, when executed by one or more processors, cause the one or more processors to perform operations comprising receiving telemetry data collected during execution of an operational maneuver by a vehicle, wherein the operational maneuver is performed as part of a planned operational sequence of one or more maneuvers, processing the telemetry data to determine a transfer function of a control system of the vehicle, the processing including applying one or more transformations to the telemetry data based on an order of a reference input command associated with the operational maneuver, and estimating one or more stability margins of the vehicle control system based on the transfer function.

Aspects may have one or more of the following advantages.

Among other advantages, aspects eliminate the need for accurate pre-flight modeling of the system and enable prediction of stability margins for vehicles with nonlinear time-varying dynamic systems. The approach validates stability margins using only operational telemetry data, without requiring dedicated test maneuvers or signal injection that could disrupt vehicle operations.

Among other advantages, aspects can be used to estimate stability margins in real time for various aerospace vehicle dynamics from slow-moving space stations to fast maneuvering rockets and lunar landers.

Aspects eliminate the shortcomings of previous approaches by using real time telemetry data. An accurate modeling of the system is advantageously unnecessary and stability margins of in-flight vehicles with nonlinear time-varying dynamic systems can be predicted.

Aspects are advantageously applicable to other vehicle types including undersea vehicles, submarines, autonomous underwater vehicles, and surface vessels, where real-time stability margin estimation during operation is critical for mission success and vehicle safety.

Aspects advantageously enable “black box” functionality similar to event data recorders (EDRs) in automobiles and flight data recorders (FDRs) in aircraft, allowing continuous monitoring and recording of stability margins during vehicle operation. This recorded stability margin history can be used for post-operation model reconstruction, reliability assessment of reusable vehicles, and root cause analysis of stability degradation events.

Aspects further advantageously enable stability margin analysis of proprietary control systems where source code is unavailable, such as when commercial service providers supply only compiled control libraries. The methods described herein can evaluate the stability margins of such “black box” control systems using only telemetry data from operational maneuvers.

Other features and advantages of the invention are apparent from the following description, and from the claims.

### BRIEF DESCRIPTION OF THE DRAWINGS

FIG. 1 is a spacecraft orbiting Earth.

FIG. 2 is a block diagram of the spacecraft.

FIG. 3 is a control system for the spacecraft.

FIG. 4 is a stability margin estimator.

FIG. 5 is a Nichols plot.

FIG. 6 is an example spacecraft control system.

FIG. 7 is the attitude and rate commands for a first numerical example.

FIG. 8 is the telemetry data for the first numerical example.

FIG. 9 is the Bode diagram for the first numerical example.

FIG. 10 is the stability margin verification for the first numerical example.

FIG. 11 is the attitude and rate commands for a second numerical example.

FIG. 12 is the telemetry data for the second numerical example.

FIG. 13 is the Bode diagram for the second numerical example.

FIG. 14 is the stability margin verification for the second numerical example.

FIG. 15 is the attitude and rate commands for a third numerical example.

FIG. 16 is the telemetry data for the first numerical example.

FIG. 17 is the Bode diagram for the first numerical example.

FIG. 18 is the stability margin verification for the third numerical example.

### DETAILED DESCRIPTION

### 1 Overview

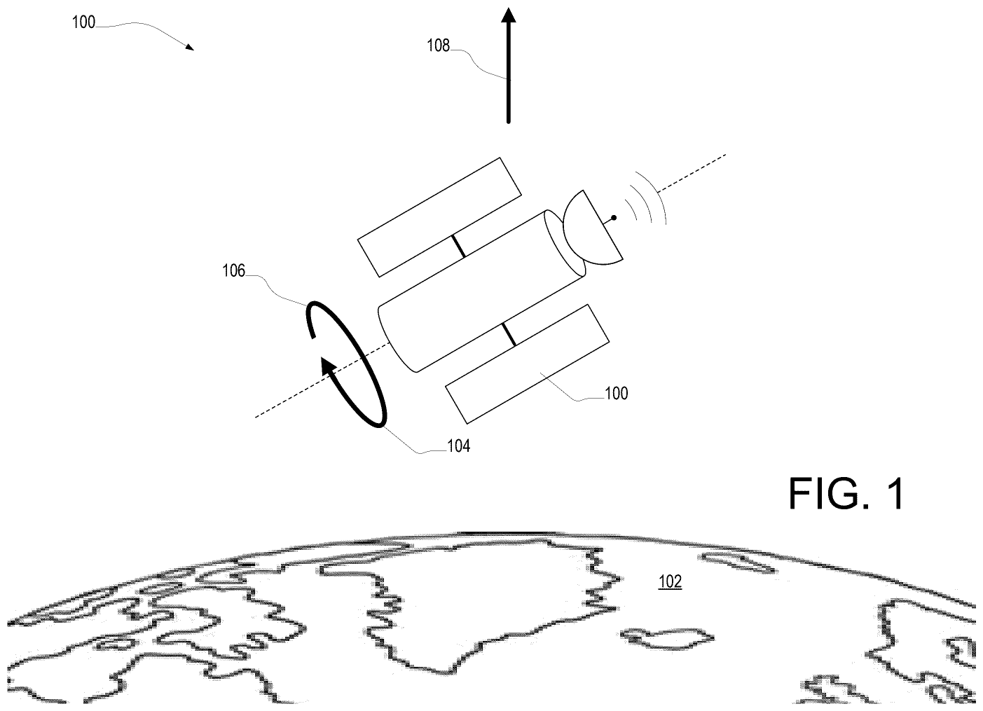

Referring to FIG. 1, a spacecraft 100 (e.g., a satellite) is orbiting a planet such as Earth 102. During its time in orbit, the spacecraft 100 performs operational maneuvers such as attitude maneuvers 104 (i.e., rotational movements to orient the spacecraft in a desired direction), rate maneuvers 106 (i.e., changes in angular velocity or spin rate), and boost maneuvers 108 (i.e., thrust operations to change orbital altitude or velocity). Very generally, a control system on board the spacecraft 100 issues commands to actuators to cause these planned on-orbit operations. Telemetry data collected during the operational maneuvers is processed to estimate substantially real-time stability margins of the spacecraft without requiring injection of test signals, as is described in greater detail below. The estimated stability margins are used, for example, as an early warning system that control of the spacecraft 100 may become unstable.

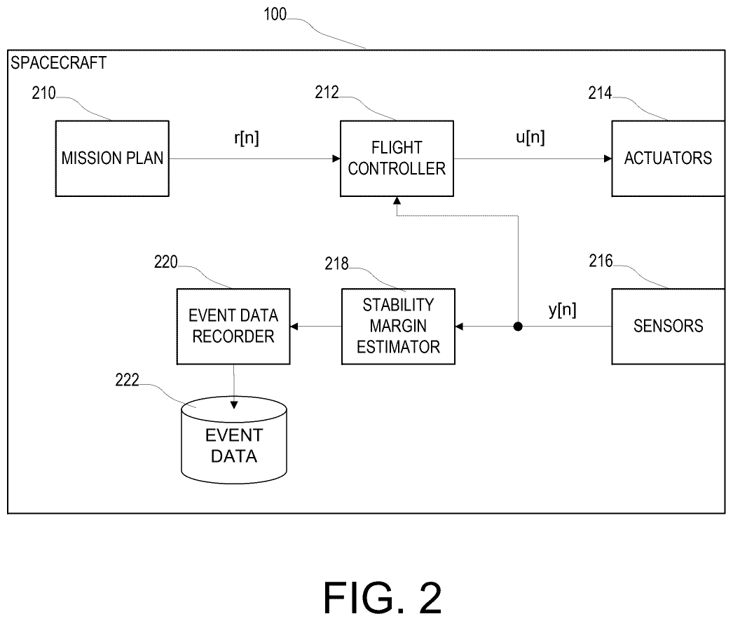

Referring to FIG. 2, the spacecraft 100 includes a mission plan 210, a flight controller 212, actuators 214, sensors 216, a stability margin estimator 218, an event data recorder 220, and an event data store 222. The mission plan 210 includes a sequence of planned maneuvers for controlling the position and orientation of the spacecraft 100 throughout its mission. The actuators 214 include thrusters and control surfaces that physically adjust the spacecraft's position and attitude. The sensors 216 comprise inertial measurement units (IMUs), star trackers, sun sensors, rate gyroscopes, accelerometers, and reaction wheel speed sensors that measure the spacecraft's current state.

During operation, the mission plan 210 generates reference commands r[n] that specify desired spacecraft states, such as target attitude angles, angular rates, or orbital positions (i.e., corresponding to one or more operational maneuvers). The flight controller 212 receives these reference commands and computes control signals u[n] based on the difference between the commanded state and the current spacecraft state. These control signals are sent to the actuators 214, which execute the commands by applying forces and torques to the spacecraft 100, thereby changing its attitude, angular rate, or orbital velocity.

The sensors 216 continuously measure the spacecraft's actual state, including but not limited to acceleration, position, velocity, angular rates, forces (including G-forces and centrifugal forces), and structural stresses. These measurements are obtained through various sensor types including inertial measurement units (IMUs), star trackers, sun sensors, rate gyroscopes, accelerometers, and reaction wheel speed sensors. The sensor measurements produce output signals y[n] that represent current attitude, angular rates, and other relevant parameters. These sensor measurements constitute the telemetry data that is transmitted to ground stations and/or recorded onboard. The output signals, y[n] are fed back to the flight controller 212, which compares them with the reference commands r[n] to generate error signals. The flight controller 212 then computes updated control signals u[n] to minimize these errors, forming a closed-loop feedback control system. Under stable control conditions, this feedback mechanism drives the spacecraft 100 to converge to the desired state specified by the mission plan 210.

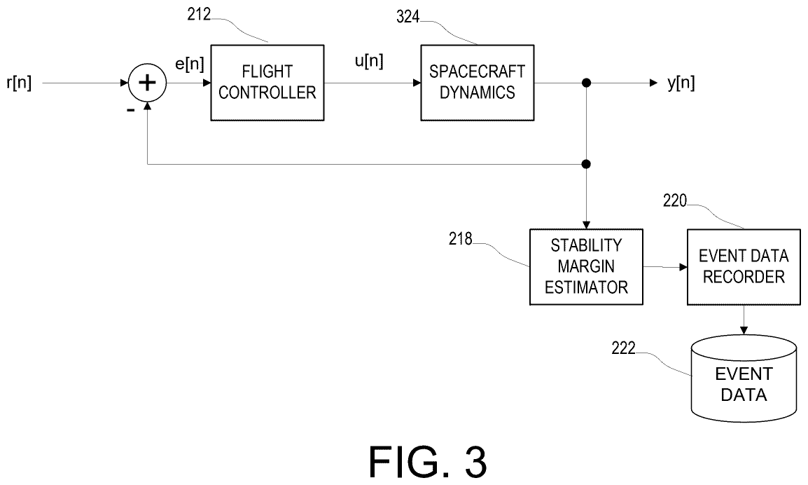

Referring to FIG. 3, a simplified block diagram representation of the spacecraft control system is shown. In this abstracted view, the actuators 214, sensors 216, and physical dynamics of the spacecraft are combined into a single plant block 324 titled “spacecraft dynamics.” The representation of FIG. 3 highlights the control loop structure while the mission plan 210 (shown in FIG. 2) is represented simply as the reference input r[n].

As described above with respect to FIG. 2, the flight controller 212 operates on the error signal e[n], which is the difference between the reference command r[n] and the measured output y[n]. The control signals u[n] generated by the flight controller 212 are applied to the spacecraft dynamics, which encompasses the signal path from actuator commands through spacecraft motion to sensor measurements.

The stability margin estimator 218 monitors the telemetry data, y[n] as the control loop operates. As is described in detail below, the stability margin estimator 218 analyzes the telemetry data from normal spacecraft maneuvers to estimate real-time stability margins without injecting test signals or otherwise disturbing the control system operation.

The stability margin estimator 218 outputs the computed stability margins to the event data recorder 220, which stores them in the event data store 222. In some examples, the event data recorder 220 continuously records all stability margin estimates along with corresponding timestamps and telemetry data, providing a comprehensive history for post-mission/operation analysis and trending. In other examples, the event data recorder 220 selectively records stability margin data when predefined alert conditions are met, such as when stability margins fall below threshold values that indicate increased risk of control system instability. These threshold-based recordings can trigger immediate alerts to mission operators and preserve critical data surrounding potential stability degradation events for detailed investigation. In adaptive control implementations, the stability margin estimates may be fed back to the flight controller 212 to automatically adjust controller parameters in real-time, maintaining desired stability margins as vehicle dynamics change due to fuel consumption, structural degradation, or environmental factors.

Before describing the stability margin estimator 218 in detail, the closed-loop transfer function for the spacecraft control system is derived. In general, the closed-loop transfer function can be derived from telemetry data by leveraging the relationship between time-domain convolution and frequency-domain multiplication. For a system with input u[n] and output y[n]:

$$y [ n ] = g [ n ] * u [ n ]$$

$$Y ( j ω ) = G ( j ω ) U ( j ω )$$

The frequency response of the closed-loop transfer function is then:

$$G ( s ) = Y ( s ) / U ( s )$$

$$G ( j ω ) = Y ( j ω ) / U ( j ω )$$

This approach allows direct estimation of the closed-loop frequency response from measured input-output data without requiring detailed system models. The numerical accuracy of the frequency response depends on the input signal characteristics and the quality of the FFT results, which are addressed in the following section for specific on-orbit operations. Note that while the spacecraft dynamics are continuous, all signal processing is performed on sampled telemetry data. Therefore, square bracket notation [n] is used throughout to denote discrete-time signals sampled at regular intervals.

In aerospace applications, most on-orbit control operations can be categorized as (1) attitude maneuvers and (2) rate maneuvers. These planned operations typically employ polynomial reference inputs of the form r(t)=t^{m}, where m is a nonnegative integer. For example, a step input corresponds to m=0, a ramp input to m=1, and a parabolic input to m=2. This specific structure of planned maneuver inputs enables a novel approach to extracting the closed-loop transfer function from telemetry data.

For a step input where U(s)=1/s (in the Laplace domain), the relationship between input and output becomes:

$$Y ( s ) = G ( s ) U ( s ) = G ( s ) / s$$

and rearranging yields:

$$sY ( s ) = G ( s )$$

From the Laplace transform properties, sY(s) corresponds to the derivative of the output signal, y′(t) in the time domain (assuming zero initial conditions). In the discrete-time implementation, these derivatives are approximated using finite differences applied to the sampled telemetry data y[n]. This mathematical relationship reveals that for step inputs, the closed-loop transfer function G(s) can be obtained by taking the FFT of the differentiated/differenced output signal. Doing so eliminates the numerical difficulties that arise when directly applying equation

$$G ( j ω ) = Y ( j ω ) / U ( j ω )$$

since the FFT of a step input is zero at all frequencies except DC.

This principle extends to higher-order polynomial inputs. For a ramp input where U(s)=1/s², taking the second derivative of the output, y″(t) yields the transfer function. More generally, for an input of order m, the k^{th} derivative of the output (where k=m+1) provides direct access to the closed-loop transfer function through FFT analysis.

By recognizing that planned spacecraft maneuvers inherently use these polynomial reference inputs, the stability margin estimator 218 can extract the closed-loop frequency response without injecting test signals. As is described in greater detail below, the estimator differentiates/differences the telemetry output signals the appropriate number of times based on the maneuver type, then applies FFT to obtain G(jω), enabling real-time stability assessment using only the telemetry data from normal spacecraft operations.

### 2 Stability Margin Estimation Using Robust Control Theory

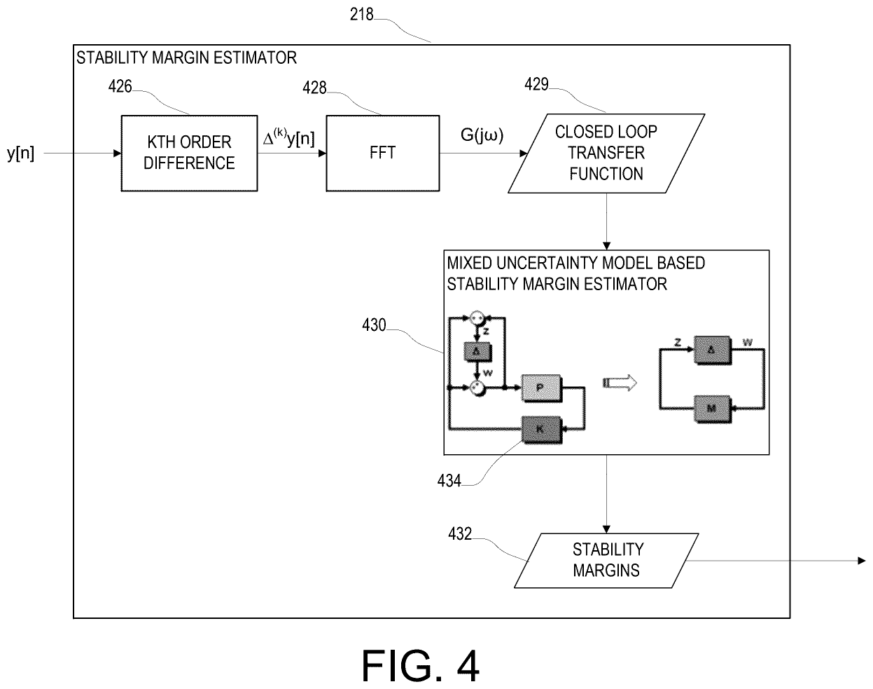

Referring to FIG. 4, the stability margin estimator 218 receives the output telemetry data, y[n], and processes it to estimate stability margins 432 for the spacecraft's control system. In some examples, the stability margin estimator 218 includes a k^{th} order difference module 426, a Fast Fourier Transform (FFT) module 428, and a mixed uncertainty model-based stability margin estimator 430.

The k^{th} order difference operator 426 determines a kth order difference of the output telemetry data, y[n] to generate a differenced signal, Δ^{k}y[n]. The differenced signal Δ^{k}y[n] is provided to the FFT module 428, which computes the discrete Fourier transform of the signal. As is described above, due to the polynomial nature of the reference input, the discrete Fourier transform of the differenced signal Δ^{k}y[n] yields the transfer function, G(jω) 429 of the spacecraft control system (where G(jω) denotes the discrete-time frequency response).

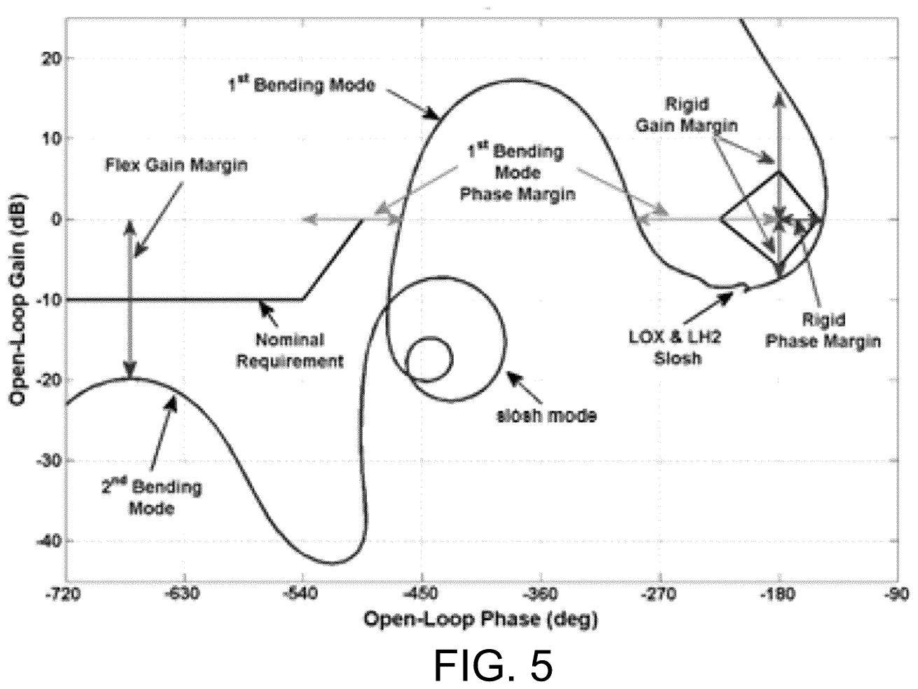

In classical control theory, a Nichols plot of the open-loop transfer function, such as that shown in FIG. 5, is used to evaluate the stability of a feedback system. The Nichols plot enables quantification of stability through gain and phase margins. These margins include the Rigid Gain Margin, which is the minimum gain margin at rigid phase crossover frequencies, and the Flex Gain Margin, which is the negative of the maximum flex peak amplitude of gain-stabilized modes. Additionally, the Rigid Phase Margin represents the minimum phase margin at rigid gain crossover frequency, while the Flex Phase Margin is the minimum phase margin at the flex gain crossover frequencies.

For a Single Input Single Output (SISO) system, the open-loop transfer function L is related to the closed-loop transfer function T by:

$$T = \frac{L}{1 + L}$$

$$and$$

$$L = \frac{T}{1 - T}$$

While the procedures described above can derive the closed-loop frequency response using FFT of telemetry data, recovering the open-loop response L from the closed-loop response T presents numerical challenges. Specifically, when the denominator (1−T) approaches zero, the calculation becomes numerically unstable, potentially producing inaccurate or undefined results.

To overcome this limitation and improve the robustness of real-time stability margin estimation, the transfer function G (jω) of the spacecraft control system is provided to the mixed uncertainty model-based stability margin estimator 430, which employs Multiple Input Multiple Output (MIMO) stability margin theory. In general, MIMO stability margin theory is a robust control framework that can estimate stability margins directly from closed-loop frequency responses without requiring the potentially problematic conversion to open-loop form described above. By avoiding the numerical instabilities associated with the (1−T) term, the MIMO approach provides reliable stability assessments even when traditional SISO methods would fail.

In one example, the multivariable gain and phase margin calculations are based on small gain theory, which provides conditions for robust stability of feedback systems with bounded uncertainties. The mixed uncertainty model-based stability margin estimator 430 implements this approach by placing a mixed uncertainty model at the output of the controller 434, as shown on the left-hand side of the estimator 430 in the diagram of FIG. 4.

The mixed uncertainty model represents simultaneous gain and phase variations that the control system might experience during operation. These variations can result from factors such as actuator degradation, sensor drift, structural changes due to fuel consumption, or unmodeled dynamics. In some examples, the uncertainty is modeled as a complex multiplier Δ that can vary within a disk of radius r in the complex plane, represented as re^{jθ} where θ∈[0, 2π].

To enable practical computation, the system shown on the left side of the estimator 430 in the diagram in FIG. 4 is transformed into the standard M-A form shown on the right side. In this representation, M is the generalized plant that includes the nominal controller K and plant P, with inputs w and outputs z that interface with the uncertainty block A. The closed-loop transfer function from w to z through M is:

$$M = [ \begin{matrix}{A}_{M} & {B}_{M} \\ {C}_{M} & {D}_{M}\end{matrix} ]$$

The loop gain of the M−Δ form of the system is MΔ (where MΔ represents the series connection of M and Δ in the feedback loop), and the loop is stable if MΔ<1. Under the small gain theory, the system remains stable if σ̅(M)σ̅(Δ)<1, where σ̅(M) is the maximum singular value of M (i.e., the largest possible amplification that the system M can produce for any input) and σ̅(Δ) is the maximum singular value of Δ (i.e., the largest possible amplification that the uncertainty Δ can produce for any input). Since the uncertainty Δ has maximum singular value r, this condition becomes σ̅(M)<1/r, or equivalently, r<1/σ̅(M). In some examples, the mixed uncertainty model-based stability margin estimator 430 computes σ̅(M) by evaluating the maximum singular value of the transfer function G(jω) at each frequency. For single-input single-output spacecraft systems, this simplifies to computing |G(jω)|, the magnitude of the complex transfer function.

To find the gain margins, the maximum stable value of r(ω), rₛ(ω) for each frequency is first determined as

$${r}_{s} ( ω ) = \frac{1}{\overline{σ} ( M ( ω ) )}$$

Then, the minimum value of r₃(w), rₘᵢₙ is determined as

$${r}_{min} = {min}_{ω} {r}_{s} ( ω )$$

The minimum value of rₛ(w), rₘᵢₙ represents the smallest uncertainty radius the system can tolerate before becoming unstable at any frequency (sometimes referred to as the “minimum uncertainty radius”). This worst-case value determines the overall stability margins. The uncertainty loop gain is defined as

$${L}_{Δ} = \frac{1 + Δ}{1 - Δ}$$

$$or$$

$${L}_{Δ} = \frac{1 + {re}^{j θ}}{1 - {re}^{j θ}}$$

The stability (gain) margins 432 are then determined by looking at pure gain variations (where θ=0 or π), yielding symmetric gain margins of

$$[ \frac{1 - {r}_{min}}{1 + {r}_{min}} , \frac{1 + {r}_{min}}{1 - {r}_{min}} ]$$

quantifying how much the system gain can decrease or increase before instability occurs.

### 3 Numerical Examples

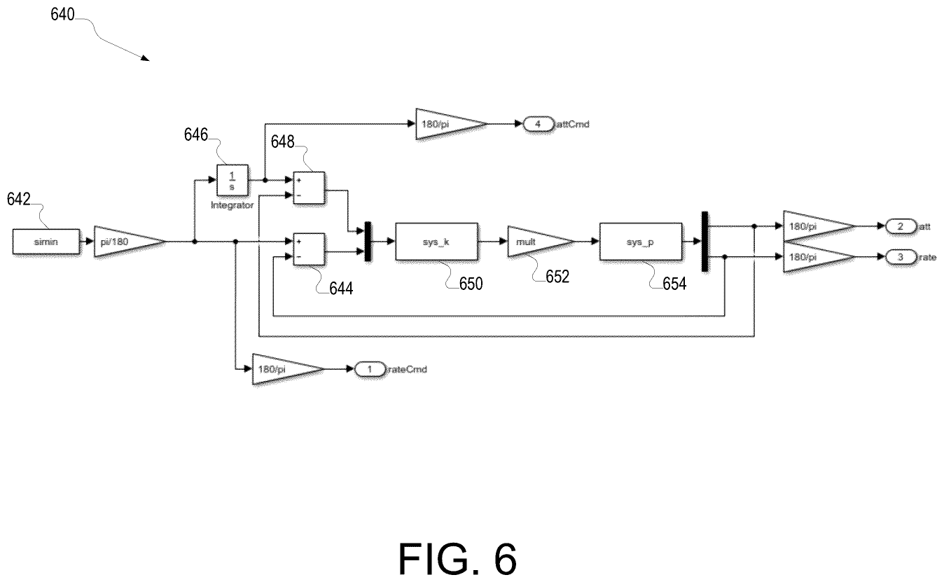

Referring to FIG. 6, a general control system architecture 640 used for verification of the stability margin estimation is shown. The control system architecture 640 includes a reference input block 642 (labeled “simin”) that generates reference commands for planned on-orbit operations. A user can specify reference inputs in the form r(t)=t^{m}, t≥0, where m is some nonnegative integer. The reference r(t) is a step input when m=0, a ramp input when m=1, and a parabolic input when m=2.

For rate control, the reference commands from block 642 represent desired angular rates and are provided directly to a first summing junction 644. For attitude control, the rate commands are also provided to an integrator block 646 that integrates the rate signal to produce an attitude reference, which is then provided to a second summing junction 648. The first summing junction 644 computes a rate error signal by subtracting the measured rate output from the rate reference. The second summing junction 648 computes an attitude error signal by subtracting the measured attitude output from the attitude reference.

Both error signals are provided to a control system block 650 (labeled “sys_k”) that includes, for example, a PID controller, flex filters, and other nonlinear elements. The control system block 650 generates control signals that are provided to a multiplier block 652 (labeled “mult”).

The multiplier block 652 applies a gain factor to the control signals, which are then provided to a plant dynamics block 654 (labeled “sys_p”). The plant dynamics block 654 includes spacecraft dynamics, actuator/sensor dynamics, and latency. In some examples, the spacecraft dynamics model includes of rigid, slosh, and flex dynamics. The plant dynamics block 654 produces two outputs: a rate output (labeled “rate”) that is fed back to the first summing junction 644, and an attitude output (labeled “att”) that is fed back to the second summing junction 648, thereby completing the feedback control loops.

To verify the estimated stability margins, the gain factor in the multiplier block 652 is set to the estimated margin value. If the system becomes unstable with this gain factor applied, the stability margin estimate is confirmed.

### 3.1 On-Orbit Attitude Maneuver for Low-Bandwidth Controlled Spacecraft

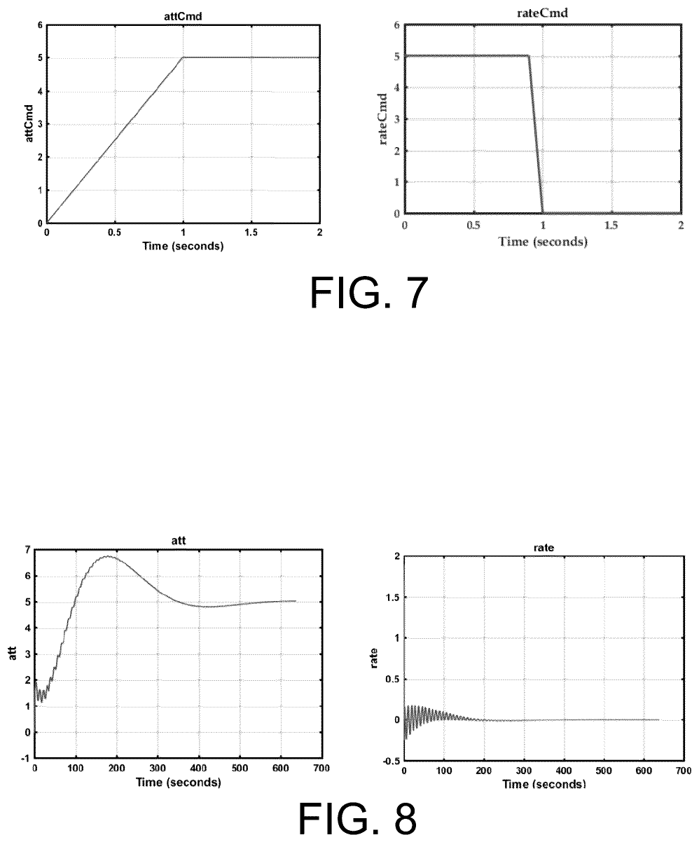

FIGS. 7-10 illustrate the operation and validation of the stability margin estimation method for an example including an on-orbit attitude maneuver for a flexible spacecraft controlled by a low-bandwidth controller. In this numerical example, the spacecraft performs a 5-degree attitude maneuver using a controller with a bandwidth of 0.002 Hz. The telemetry data is sampled at 10 Hz.

FIG. 7 shows the reference commands generated by the reference input block 642. The left plot shows the attitude command, which ramps from 0 to 5 degrees over approximately 1 second and then maintains the 5-degree commanded attitude. The right plot shows the rate command, which is a step function that commands 5 degrees/second angular rate for 1 second before returning to zero. This rate command profile, when integrated by integrator block 646, produces the attitude command shown in the left plot.

FIG. 8 shows the telemetry data comprising the actual spacecraft response sampled at 10 Hz and measured at the outputs of the plant dynamics block 654. The left plot shows the attitude output over 700 seconds, which follows the commanded 5-degree attitude change but exhibits overshoot to approximately 6.5 degrees and subsequent oscillations due to, for example, spacecraft flexible modes before settling at the commanded attitude. The right plot shows the rate output, which exhibits a peak rate of approximately 1.5 degrees/second followed by oscillations characteristic of flexible spacecraft dynamics. These oscillations in both attitude and rate outputs represent the actual telemetry data y[n] that is processed by the stability margin estimator 218.

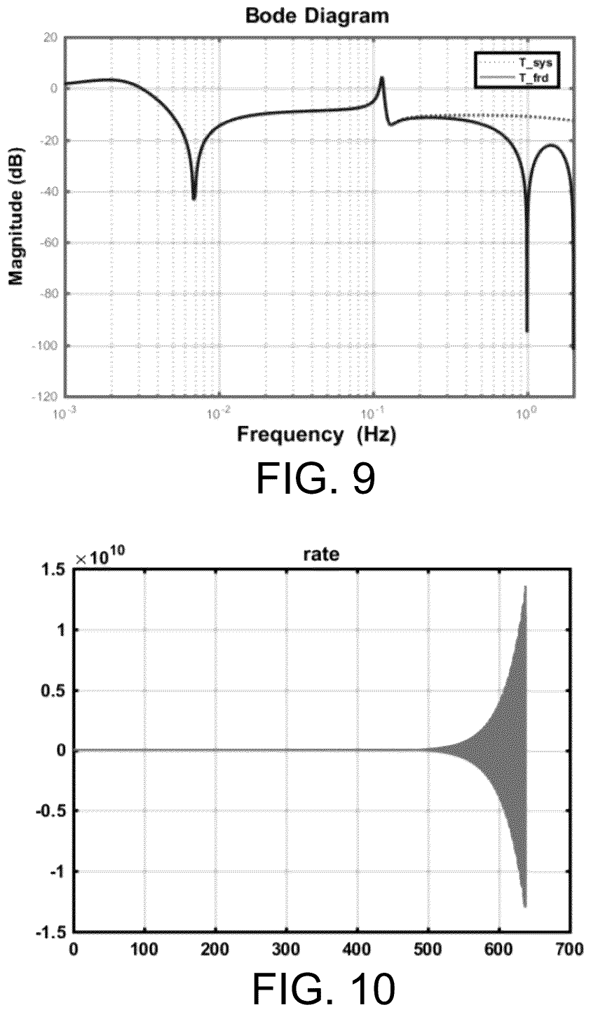

FIG. 9 shows a Bode diagram comparing the closed-loop frequency response derived from the 10 Hz sampled telemetry data (labeled T_frd, shown as solid line) with the analytical closed-loop frequency response computed from the known system model (labeled T_sys, shown as a dotted line). The close agreement between these two responses validates that the method correctly extracts the closed-loop transfer function G(jω) from the telemetry data. The frequency response shows characteristic rigid body behavior at low frequencies (below 10\hat{ }−2 Hz) and flexible mode peaks at higher frequencies (around 10\hat{ }−1 Hz), demonstrating both rigid and flexible dynamics of the spacecraft.

FIG. 10 shows the stability margin verification results. The MIMO stability gain margin based on the derived closed-loop response is 11.75 dB. To verify this estimated gain margin, the multiplier block 652 is set to a gain of 1.17 (since 20*log 10(1.17)≈1.36 dB, and the system already has approximately 10.4 dB of inherent gain), and the simulation is re-run. As expected, the rate output exhibits sustained large-amplitude oscillations of approximately ±1.5×10\hat{ }10 degrees/second, confirming that the system is at the stability boundary. This verification demonstrates that the MIMO stability margin estimation correctly predicted the gain increase that would drive the flexible spacecraft system to instability.

### 3.2 On-Orbit Rate Maneuver for Low-Bandwidth Controlled Spacecraft

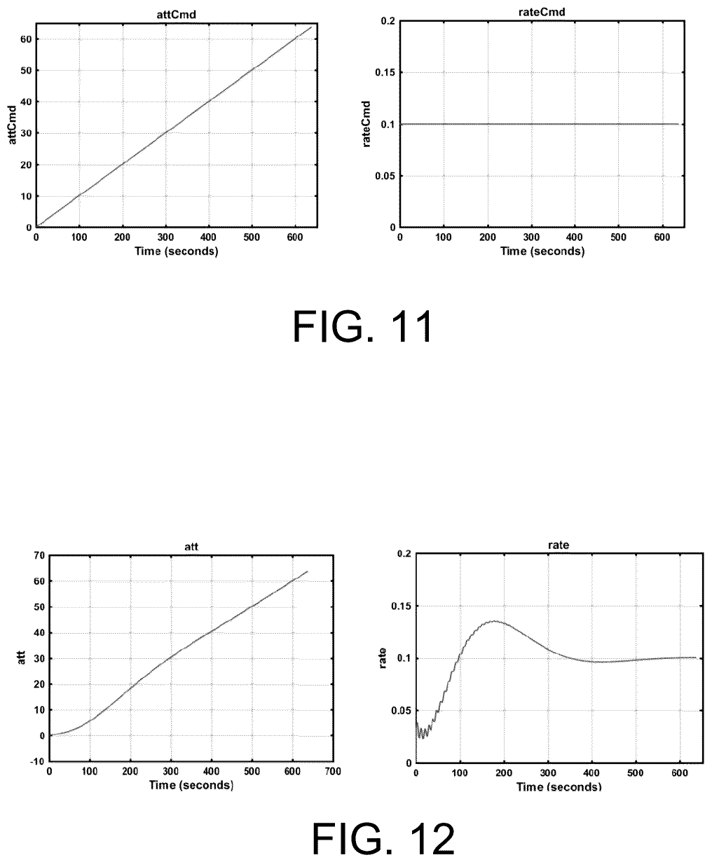

FIGS. 11-14 illustrate the operation and validation of the stability margin estimation method for another example, including an on-orbit rate maneuver for a flexible spacecraft controlled by a low-bandwidth controller. In this numerical example, the spacecraft performs a 0.1 degrees/second rate maneuver using a controller with a bandwidth of 0.002 Hz. The telemetry data is sampled at 10 Hz.

FIG. 11 shows the reference commands generated by the reference input block 642. The left plot shows the attitude command, which ramps linearly from 0 to approximately 65 degrees over 600 seconds, corresponding to the integral of the constant rate command. The right plot shows the rate command, which is a step function that commands a constant 0.1 degrees/second angular rate throughout the maneuver. This constant rate command, when integrated by integrator block 646, produces the linearly increasing attitude command shown in the left plot.

FIG. 12 shows the telemetry data comprising the actual spacecraft response sampled at 10 Hz and measured at the outputs of the plant dynamics block 654. The left plot shows the attitude output over 700 seconds, which follows the commanded linear attitude increase but exhibits an initial transient overshoot to approximately 0.15 degrees/second before settling to track the commanded ramp. The right plot shows the rate output, which exhibits an initial transient response with overshoot to approximately 0.15 degrees/second, followed by oscillations due to flexible modes, before settling to the commanded 0.1 degrees/second rate. These responses represent the actual telemetry data y[n] that is processed by the stability margin estimator 218.

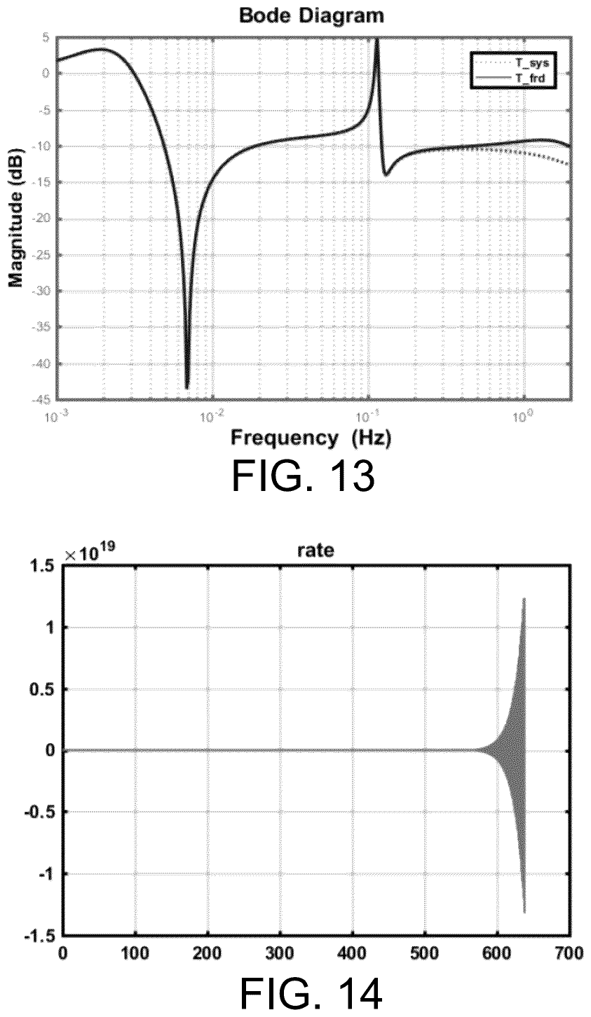

FIG. 13 shows a Bode diagram comparing the closed-loop frequency response derived from the 10 Hz sampled telemetry data (labeled T_frd, shown as solid line) with the analytical closed-loop frequency response computed from the known system model (labeled T_sys, shown as a dotted line). The close agreement between these two responses validates that the method correctly extracts the closed-loop transfer function G(jω) from rate maneuver telemetry data. The frequency response shows similar characteristics to the example above, with rigid body behavior at low frequencies and flexible mode peaks at higher frequencies, demonstrating that the method works equally well for rate maneuvers.

FIG. 14 shows the stability margin verification results. The MIMO stability gain margin based on the derived closed-loop response is 11.42 dB. To verify this estimated gain margin, the multiplier block 652 is set to a gain of 1.22, and the simulation is re-run. The rate output exhibits sustained large-amplitude oscillations of approximately ±1.5×10\hat{ }10 degrees/second, confirming that the system is at the stability boundary. This verification demonstrates that the MIMO stability margin estimation correctly predicted the gain increase that would drive the system to instability during a rate maneuver, showing that the method is applicable to different types of spacecraft maneuvers.

### 3.3 On-Orbit Attitude Maneuver for High-Bandwidth Controlled Spacecraft

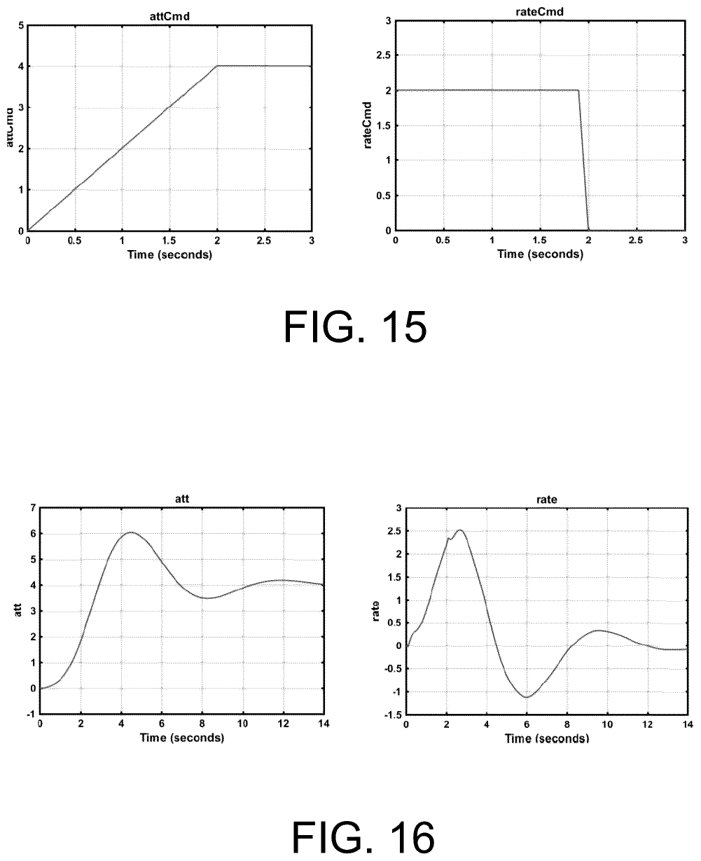

FIGS. 15-18 illustrate the operation and validation of the stability margin estimation method for another example including an on-orbit attitude maneuver for a flexible spacecraft controlled by a high-bandwidth controller. In this numerical example, the spacecraft performs a 4-degree attitude maneuver using a controller with a bandwidth of 0.1 Hz, which is 50 times higher than the controllers in the two examples above. The telemetry data is sampled at 10 Hz.

FIG. 15 shows the reference commands generated by the reference input block 642. The left plot shows the attitude command, which ramps from 0 to 4 degrees over approximately 2 seconds and then maintains the 4-degree commanded attitude. The right plot shows the rate command, which is a step function that commands 2 degrees/second angular rate for 2 seconds before returning to zero. This rate command profile, when integrated by integrator block 646, produces the attitude command shown in the left plot.

FIG. 16 shows the telemetry data comprising the actual spacecraft response sampled at 10 Hz and measured at the outputs of the plant dynamics block 654. The left plot shows the attitude output over 14 seconds, which follows the commanded 4-degree attitude change but exhibits significant overshoot to approximately 6 degrees, followed by oscillations including an undershoot to approximately 3 degrees before settling at the commanded attitude. The right plot shows the rate output, which exhibits a peak rate of approximately 2.5 degrees/second followed by large oscillations including negative rates of approximately −1.5 degrees/second. These more pronounced oscillations compared to the examples above are characteristic of the higher bandwidth controller exciting the flexible modes more strongly.

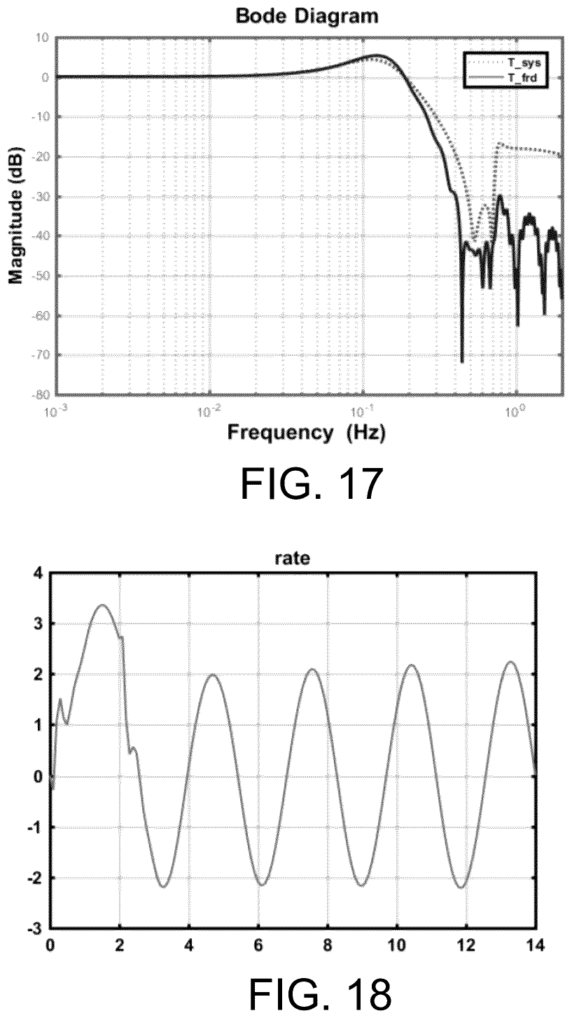

FIG. 17 shows a Bode diagram comparing the closed-loop frequency response derived from the 10 Hz sampled telemetry data (labeled T_frd, shown as solid line) with the analytical closed-loop frequency response computed from the known system model (labeled T_sys, shown as a dotted line). The frequency response shows the higher bandwidth characteristics with the gain crossover frequency near 0.1 Hz. Multiple flexible mode peaks are visible in the frequency range from 10\hat{ }−1 to 10\hat{ }0 Hz, with some peaks showing gains above 0 dB, indicating the reduced stability margins compared to the low-bandwidth controller cases.

FIG. 18 shows the stability margin verification results. The MIMO stability gain margin based on the derived closed-loop response is 10.54 dB, which is lower than the margins in the examples above, as expected for a higher bandwidth controller. To verify this estimated gain margin, the multiplier block 652 is set to a gain of 1.7, and the simulation is re-run. The rate output exhibits sustained oscillations with a distinctive pattern showing approximately 5 cycles over 14 seconds, with peak amplitudes of approximately ±3.5 degrees/second. These sustained oscillations confirm that the system is at the stability boundary. This verification demonstrates that the MIMO stability margin estimation method accurately predicts stability margins across different controller bandwidths, from the very low bandwidth (0.002 Hz) controllers in the previous examples to the significantly higher bandwidth (0.1 Hz) controller in this example.

### 4 Alternatives

While the embodiments described herein primarily reference spacecraft for clarity of explanation, it should be understood that the systems and methods disclosed are applicable to various types of vehicles operating in different environments. These vehicles may include, but are not limited to, spacecraft, satellites, orbital return vehicles, lunar landers, rockets, missiles, aircraft, undersea vehicles, submarines, autonomous underwater vehicles (AUVs), surface ships, and terrestrial vehicles operating in challenging dynamic environments.

In some examples, the stability margin estimator 218 described above implements a multi-step process for extracting stability information from telemetry data. First, the estimator collects attitude control command and attitude response data from the control loop during actual vehicle operation. The estimator then determines the magnitude and function type of attitude control commands within a particular time window. If the slope of the attitude command can be approximated as constant, the attitude command is classified as either a step or ramp response function. Otherwise, the estimator determines the order of attitude commands using polynomial approximation. The attitude response data is scaled using the magnitude of the attitude command, and flexible mode motion may be filtered from the scaled attitude response data to ensure the rigid body response is retained, with the filter bandwidth set slightly below the first bending mode frequency of the vehicle.

In some examples, the stability margin estimator 218 functions as a “black box” recorder similar to event data recorders (EDRs) used in automobiles or flight data recorders (FDRs) used in aircraft. The system continuously monitors and records real-time stability margins during vehicle operation. If stability margins decrease below nominal values, this can indicate various failure modes including sensor failures, navigation software issues, actuator failures (such as gimbal lock, thrust valve stuck, or engine failure), control software issues, or mass property estimation errors. The recorded stability margin history provides valuable diagnostic information for post-incident analysis.

For reusable vehicles such as reusable launch vehicles, spacecraft, or aircraft, the system can build a comprehensive stability margin history over multiple missions or flights. This historical data enables tracking of stability margin degradation over time, providing reliability evidence for the reusable vehicle. The stability margin trends can be analyzed to determine root causes of degradation and verify the effectiveness of control system enhancements implemented to improve robustness. For example, a reusable spacecraft might show gradually decreasing stability margins over multiple missions due to actuator wear or structural changes, prompting preventive maintenance before margins fall below safe thresholds.

The methods described herein can be used for post-operation model reconstruction. By comparing recorded stability margins from actual operations with pre-flight predictions, engineers can refine vehicle models to better match real-world behavior. This reconstruction can improve modeling of complex phenomena such as propellant slosh dynamics under varying gravity conditions (zero-g, low-g, high-g), structural frequency and damping uncertainties, transient thrust profiles, end-to-end latency in the guidance, navigation and control system, and the effectiveness of adaptive control algorithms. The improved models derived from flight data can then be used for future control system designs.

In some examples, the system enables stability margin analysis of proprietary or “secret sauce” control systems where the control algorithms are provided as compiled libraries without source code access. The stability margin estimator 218 can evaluate such black-box control systems by analyzing only the telemetry data from operational maneuvers, without requiring knowledge of the internal control algorithms. This capability allows system integrators to verify the robustness of third-party control systems and perform independent safety assessments.

Examples of operational maneuvers that generate suitable telemetry data include, but are not limited to: spacecraft station-keeping and attitude hold operations such as the ISS Orbiter Repair Maneuver where attitude control maintains stability while robotic manipulators reposition attached vehicles; passive thermal control maneuvers such as the Apollo “barbecue mode” involving slow rotation about the spacecraft roll axis; and high-dynamic launch vehicle maneuvers including tower clearance maneuvers during liftoff, roll maneuvers after tower clearance to align with the launch azimuth, and pitch-over maneuvers to achieve orbital insertion trajectory. Each of these operational maneuvers provides telemetry data suitable for real-time stability margin estimation without requiring dedicated test signal injection.

### 5 Implementations

The computational resource allocation approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A system for estimating stability margins of a vehicle, the system comprising:
one or more sensors configured to collect telemetry data during execution of an operational maneuver by a vehicle, wherein the operational maneuver is performed as part of a planned operational sequence of one or more maneuvers;
one or more processors; and
memory storing instructions that, when executed by the one or more processors, cause the system to:
process the telemetry data to determine a transfer function of a control system of the vehicle, the processing including applying one or more transformations to the telemetry data based on an order of a reference input command associated with the operational maneuver; and
estimate one or more stability margins of the vehicle control system based on the transfer function.

2. The system of claim 1, wherein the telemetry data comprises one or more of attitude measurements, angular rate measurements, position measurements, velocity measurements, acceleration measurements, and force measurements.

3. The system of claim 1, wherein the instructions cause the system to process the telemetry data by applying the one or more transformations includes computing differenced telemetry data by applying a difference operation to the telemetry data according to the order of the reference input command.

4. The system of claim 3, wherein the instructions further cause the system to determine the order of the reference input command associated with the operational maneuver.

5. The system of claim 3, wherein processing the telemetry data further comprises applying a Fast Fourier Transform to the differenced telemetry data.

6. The system of claim 1, wherein the reference input command includes a polynomial reference input.

7. The system of claim 6, wherein the polynomial reference input is of the form r(t)=t^{m}, where m is a nonnegative integer.

8. The system of claim 7, wherein m=0 corresponds to a step input, m=1 corresponds to a ramp input, and m=2 corresponds to a parabolic input.

9. The system of claim 7, wherein the instructions cause the system to process the telemetry data by applying a k^{th} order difference operation to the telemetry data, where k=m+1.

10. The system of claim 1, wherein the instructions cause the system to process the telemetry data to determine the transfer function without using input command signals in the transfer function computation.

11. The system of claim 1, wherein the planned sequence of operational maneuvers comprises a mission plan for the vehicle.

12. The system of claim 1, wherein the transfer function is a closed-loop transfer function representing a frequency response from reference commands to measured outputs.

13. The system of claim 12, wherein the instructions cause the system to estimate the one or more stability margins by applying Multiple Input Multiple Output (MIMO) stability margin theory to the closed-loop transfer function.

14. The system of claim 13, wherein the instructions cause the system to apply MIMO stability margin theory by:
determining a maximum singular value of the closed-loop transfer function at each frequency; and
computing gain margins based on a minimum uncertainty radius determined from the maximum singular value of the closed-loop transfer function at each frequency.

15. The system of claim 1, wherein the operational maneuver comprises at least one of an attitude maneuver or a rate maneuver.

16. The system of claim 1, wherein the instructions further cause the system to store the estimated stability margins in a data store with corresponding timestamps for post-operation analysis.

17. The system of claim 1, wherein the instructions further cause the system to automatically adjust control parameters of the vehicle control system based on the estimated stability margins to maintain desired stability margins as vehicle dynamics change.

18. The system of claim 1, wherein the instructions further cause the system to generate an alert when at least one of the estimated stability margins falls below a predetermined threshold value.

19. A method for estimating stability margins of a vehicle control system, the method comprising:
receiving telemetry data collected during execution of an operational maneuver by a vehicle, wherein the operational maneuver is performed as part of a planned sequence of one or more operational maneuvers;
processing the telemetry data to determine a transfer function of the vehicle control system, the processing including applying one or more transformations to the telemetry data based on an order of a reference input command associated with the operational maneuver; and
estimating one or more stability margins of the vehicle control system based on the transfer function.

20. A non-transitory computer-readable medium storing instructions that, when executed by one or more processors, cause the one or more processors to perform operations comprising:
receiving telemetry data collected during execution of an operational maneuver by a vehicle, wherein the operational maneuver is performed as part of a planned operational sequence of one or more maneuvers;
processing the telemetry data to determine a transfer function of a control system of the vehicle, the processing including applying one or more transformations to the telemetry data based on an order of a reference input command associated with the operational maneuver; and
estimating one or more stability margins of the vehicle control system based on the transfer function.
